(19) United States
(12) Patent Application Publication
(10) Pub. No.: US 2015/0207152 A1
(43) Pub. Date: Jul. 23, 2015

(54) ELECTRODE CATALYST FOR FUEL CELL, METHOD OF PREPARING THE SAME, ELECTRODE FOR FUEL CELL INCLUDING THE ELECTROLYTE CATALYST, AND FUEL CELL INCLUDING THE ELECTRODE

(71) Applicant: Samsung SDI Co., Ltd., Yongin-si (KR)

(72) Inventors: Jun-Young Kim, Yongin-si (KR); Yeon-Su Kim, Yongin-si (KR); Sung-Chul Lee, Yongin-si (KR); Tae-Yoon Kim, Yongin-si (KR); Hee-Tak Kim, Yongin-si (KR)

(73) Assignee: Samsung SDI Co., Ltd., Yongin-si (KR)

(21) Appl. No.: 14/295,139

(22) Filed: Jun. 3, 2014

(30) Foreign Application Priority Data
Jan. 23, 2014 (KR) 10-2014-0008295

(51) Int. Cl. H01M 4/86; H01M 8/10; H01M 4/92

(52) U.S. Cl. CPC H01M 4/8663; H01M 4/926; H01M 8/1004; H01M 2008/1095; H01M 2300/0082

(57) ABSTRACT

In an aspect herein is provided an electrode catalyst for a fuel cell including a carbonaceous carrier and a metal catalyst supported in the carbonaceous carrier, wherein an amino C₆-C₃₀ polycyclic aromatic hydrocarbon compound is non-covalently bonded to the surface of the carbonaceous carrier, an electrode comprising said catalyst and a fuel cell including the electrode catalyst and electrode.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. For example, this application claims priority to and the benefit of Korean Application No. 10-2014-0008295, filed on Jan. 23, 2014, in the Korean Intellectual Property Office, the disclosure of which is incorporated herein in its entirety by reference.

### BACKGROUND

1. Field

The described technology relates to an electrode catalyst for a fuel cell, a method of manufacturing the electrode catalyst for a fuel cell, an electrode for a fuel cell containing the instant electrode catalyst and a fuel cell including the instant electrode catalyst.

2. Description of the Related Technology

A fuel cell may be categorized as a polymer electrolyte membrane fuel cell (PEMFC), a direct methanol fuel cell (DMFC), a phosphoric acid fuel cell (PAFC), a molten carbonate fuel cell (MCFC), a solid oxide fuel cell (SOFC), and the like.

The PEMFC and the DMFC conventionally include a membrane-electrode assembly (MEA) including an anode, a cathode, and a polymer electrolyte membrane disposed between the anode and the cathode. The anode of the fuel cell includes a catalyst layer for oxidizing a fuel and the cathode includes a catalyst layer for reducing an oxidizing agent.

However, the electrochemical surface area (ECSA) of a metal catalyst may be reduced due to corrosion and agglomeration of carbonaceous carriers that occur during the operation of a fuel cell. Due to this corrosion and agglomeration the use of an electrode catalyst that includes a metal catalyst may reduce the activity and the durability of the electrode catalyst. Thus, improvements are needed.

### SUMMARY OF CERTAIN INVENTIVE ASPECTS

In some embodiments disclosed herein, there is provided an amino electrode catalyst for a fuel cell including a carbonaceous carrier and a metal catalyst supported in the carbonaceous carrier, wherein the carbonaceous carrier is non-covalently bonded to a C₆-C₃₀ polycyclic aromatic hydrocarbon compound having an amino group at an end thereof, on the surface of the carbonaceous carrier.

In some embodiments there is provided an electrode for a fuel cell including the electrode catalyst.

In some embodiments there is provided a fuel cell including a cathode, an anode that is disposed opposite to the cathode, and an electrolyte membrane disposed between the cathode and the anode, wherein at least one of the cathode and the anode includes the electrode catalyst.

Use of the instant electrode catalyst for a fuel cell according to embodiments herein results in a fuel cell having improved durability and activity.

### BRIEF DESCRIPTION OF THE DRAWINGS

FIG. 1 illustrates an interaction between a carbonaceous carrier and a polyaromatic compound having an amino group at an end thereof, wherein the compound is non-covalently bonded to a surface of the carbonaceous carrier in an electrode catalyst according to a present embodiment;

FIG. 2 is an exploded perspective view showing an embodiment of a fuel cell;

FIG. 3 is a schematic view of a cross-section of a membrane electrode assembly (MEA) in a fuel cell;

FIG. 4 is an image of high-resolution transmission electron microscopy (HRTEM/SAED)/selected area electron diffraction (SAED) analyses of the electrode catalyst manufactured according to Example 1;

FIG. 5 is an image of high-resolution transmission electron microscopy (HRTEM/SAED)/selected area electron diffraction (SAED) analyses of the electrode catalyst manufactured according to Example 1;

FIG. 6 is an image of high-resolution transmission electron microscopy (HRTEM/SAED)/selected area electron diffraction (SAED) analyses of the electrode catalyst manufactured according to Example 1;

FIG. 7 shows results of x-ray diffraction (XRD) analysis of the carbonaceous carrier and the electrode catalyst of Example 1;

FIG. 8 shows results of x-ray diffraction (XRD) analysis of the carbonaceous carrier and the electrode catalyst Comparative Example 1;

FIG. 9 shows a Raman spectrum of the carbonaceous carrier used during the manufacturing of the electrode catalyst of Example 1; and

FIG. 10 shows the extent of reduction of an electrochemical surface area (ECSA) of the electrode catalyst in the negative electrode according to Example 1 and Comparative Examples 1 and 2.

### DETAILED DESCRIPTION OF CERTAIN INVENTIVE EMBODIMENTS

Hereinafter, an electrode catalyst for a fuel cell according to an embodiment, an electrode for a fuel cell including the electrode catalyst, a method of manufacturing the electrode, and a fuel cell including the electrode containing the electrode catalyst will be described in detail.

The electrode catalyst for a fuel cell includes a carbonaceous carrier and a metal catalyst loaded on the carbonaceous carrier, further wherein the carbonaceous carrier is non-covalently bonded to a C₆-C₃₀ polycyclic aromatic hydrocarbon compound having an amino group at an end thereof, on the surface of the carbonaceous carrier.

As used herein, a non-covalent bond refers to a π-π interaction between one or more phenyl rings of the C₆-C₃₀ polycyclic aromatic hydrocarbon compound having an amino group at an end thereof and carbon of the carbonaceous carrier. Due to the non-covalent bond, the amino group of the C6-C₃₀ polycyclic aromatic hydrocarbon compound having an amino group at an end thereof is located far away from the carbonaceous carrier.

The amino group may be of the formula -L-N(R₁)(R₂), wherein R₁ and R₂ may be each independently a hydrogen, a C₁-C₁₀ alkyl group or a C₆-C₁₀ aryl group, and L may simply represent a chemical bond or a C₂-C₁₀ alkylene group or a C₆-C₁₀ arylene group. For example, the amino group may be —NH₂, —NH(CH₃), or —(CH₂)ₙ—NH₂ (wherein n is an integer from 1 to 10).

The C₆-C₃₀ polycyclic aromatic hydrocarbon compound having an amino group at an end thereof is at least one selected from a naphthalene compound having an amino group at an end thereof, a phenanthrene compound having an amino group at an end thereof, a pyrene compound having an amino group at an end thereof, and a anthracene compound having an amino group at an end thereof.

The C₆-C₃₀ polycyclic aromatic hydrocarbon compound having an amino group at an end thereof may be, in greater detail, a compound represented by Formula 1 below; a compound represented by Formula 2 below; an anthracene compound including at least one amino group selected from —NH₂ and —(CH₂)ₙNH₂ (wherein n is an integer from 1 to 10); a phenanthrene compound including at least one amino group selected from —NH₂ and —(CH₂)ₙNH₂ (wherein n is an integer from 1 to 10) group; a tetracene compound including at least one amino group selected from —NH₂ and —(CH₂)ₙNH₂ (wherein n is an integer from 1 to 10); a pentacene compound including at least one selected from —NH₂ and —(CH₂)ₙNH₂ (wherein n is an integer from 1 to 10); or a triphenylene compound including at least one amino group selected from —NH₂ and —(CH₂)ₙNH₂ (wherein n is an integer from 1 to 10).

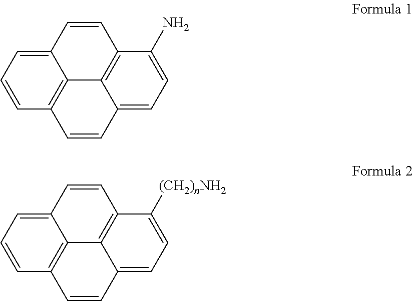

In Formula 2, n is an integer from 1 to 10.

In one embodiment, the amount of the C₆-C₃₀ polycyclic aromatic hydrocarbon compound having an amino group at an end thereof used in the instant electrode catalyst is about 0.1 parts by weight to about 50 parts by weight, based on 100 parts by weight of the carbonaceous carrier.

In one embodiment, the amount of the carbonaceous carrier that is non-covalently bonded to the C₆-C₃₀ polycyclic aromatic hydrocarbon compound having an amino group at an end thereof on the surface of the carbonaceous carrier may be about 20 parts by weight to about 80 parts by weight based on 100 parts by weight of the electrode catalyst.

When the amount of the C₆-C₃₀ polycyclic aromatic hydrocarbon compound having an amino group at an end thereof and the amount of the carbonaceous carrier are in the ranges described above, the durability and activity of the electrode catalyst containing them are excellent.

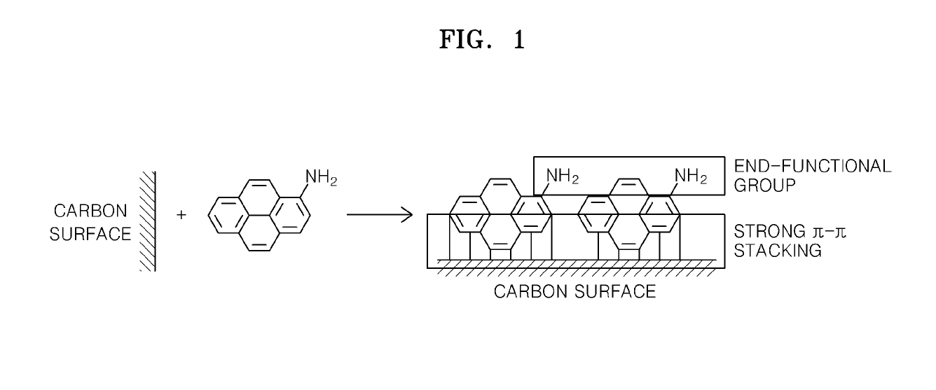

FIG. 1 illustrates an interaction between a carbonaceous carrier and a C₆-C₃₀ polycyclic aromatic compound having an amino group at an end thereof, wherein the compound is non-covalently bonded to a surface of the carbonaceous carrier in an electrode catalyst according to an instant embodiment.

Carbons of the carbonaceous carrier undergoes a π-π stacking interaction with one or more aromatic carbon rings of a C₆-C₃₀ polycyclic aromatic hydrocarbon compound having an amino group at an end thereof. The nitrogen of the amino group in the C₆-C₃₀ polycyclic aromatic hydrocarbon compound having an amino group at an end thereof, has an unshared electron pair which provides a site for binding to a metal catalyst such as platinum.

As described above, the C₆⁻C₃₀ polycyclic aromatic hydrocarbon compounds having an amino group at an end thereof is one non-covalently bonded to the carbonaceous carrier and thus, do not alter or deteriorate the structure and properties of the carbonaceous carrier. Accordingly, the metal catalyst may be uniformly dispersed on the carbonaceous carrier without agglomeration of the metal catalyst thus maintaining the stability of the electrode catalyst. As such, problems caused by the deterioration of the catalyst due to the agglomeration of the metal catalyst and electrochemical carbon corrosion, which occur during the operation of the fuel cell, may be prevented. Accordingly, the electrode catalyst may be non-covalently functionalized without the deterioration of the properties of the carbonaceous carrier and thus control the surface properties of the electrode catalyst; improving durability and electrochemical activities of the electrode catalyst. The fact that the properties of the carbonaceous carrier do not change after the amino polycyclic aromatic hydrocarbon compounds non-covalently bind to the carbonaceous carrier may be observed through Raman and x-ray diffraction (XRD) analyses.

The carbonaceous carrier is a material formed of highly crystalline carbon such as carbon black, heat-treated carbon black, heat-treated acetylene black, activated carbon, graphite, highly pure graphite, carbon nanofibers, carbon fibers, carbon nanotubes, carbon nanowires, carbon nanocages, carbon nanohorns, carbon aerogel, carbon nanorings, mesoporous carbon, ordered mesoporous carbon, graphene, or a combination thereof, but the carbonaceous carrier is not limited thereto and the carbonaceous carrier may be used alone or as a mixture of two or more thereof.

The carbonaceous carrier may include ordered mesoporous carbon having mesopores. An average diameter of mesopores in such material may be about 6 nm to about 10 nm. The ordered mesoporous carbon may be prepared by using a mesoporous silica template (for example, MSU-H or the like). The ordered mesoporous carbon has a wide specific surface area and thus, when the ordered mesoporous carbon is used as the carbonaceous carrier, the weight of the metal supported catalyst may be greater than the weight of the carbonaceous carrier.

In the electrode catalyst, an average particle diameter of the metal catalyst may be about 1 nm to about 20 nm, for example, about 3 nm to about 10 nm. When the average particle diameter of the metal catalyst is within the range described above, excellent oxygen reduction activity and electrochemical specific surface area may be maintained.

In this regard, when the average diameter of the metal catalyst of the electrode catalyst is within the range above, the activity of the catalyst including the metal catalyst is excellent.

The amount of the metal catalyst may be about 20 parts by weight to about 80 parts by weight, for example, about 30 parts by weight to about 60 parts by weight, based on 100 parts by weight of the total weight of the electrode catalyst (weight of the metal catalyst+weight of the carbonaceous carrier). In the electrode catalyst, when the amount of the metal catalyst is in the range described above, the catalyst may have excellent specific surface area and a large amount of metal supported therein and thus, the activity of the catalyst is excellent.

The metal catalyst may be at least one selected from the group consisting of platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), strontium (Sn), titanium (Ti), chromium (Cr), and a combination thereof. For example, the metal catalyst may be Pt or a Pt-Co alloy.

The electrode catalyst according to an embodiment of the present disclosure may include Pt and a carbonaceous carrier including a crystalline carbon. The electrode catalyst may be useful for manufacturing an electrode for a fuel cell of a vehicle.

The electrode catalyst has a very large specific surface area, on which various gases and/or liquids, which are subject to electrochemical reactions, may contact. The electrochemical specific surface area of the electrode catalyst may be 70 m²/g or greater, for example, in a range of about 70 m²/g to about 100 m²/g , but the electrochemical specific surface area is not limited thereto.

The instant carbonaceous carrier has a ratio of the maximum peak intensity of a D band at about 1340 cm⁻¹ to about 1360 cm⁻¹ to a maximum peak intensity of a G band at about 1575 cm⁻¹ to about 1600 cm⁻¹ in spectra obtained by Raman spectrometry using a laser having a wavelength of about 514.5 nm, of the carbonaceous carrier may be about 0.1 to about 1.5, for example, about 0.3 to about 1.0.

In the XRD spectrum of the carbonaceous carrier, a peak with respect to a (002) surface is observed at a Bragg 2θ angle of 26.4±0.1°, and a half-width of the peak with respect to the (002) surface may be about 0.2° to about 0.7°.

When the carbonaceous carrier has I_{D}/I_{G} or the half-width of the peak with respect to the (002) surface in the ranges described above, the surface structure and electrochemical properties of the carbon do not change.

Hereinafter, a method of manufacturing an electrode catalyst for a fuel cell according to an embodiment of the present disclosure will be described in greater detail.

A C₆-C₃₀ aromatic hydrocarbon compound having an amino group at an end thereof is mixed with a solvent and then a carbonaceous carrier is added thereto to obtain a carbonaceous carrier mixture.

As the solvent, at least one selected from methanol, ethanol, water, N,N-dimethyl sulfoxide, and N,N-dimethyl formamide is used.

The carbonaceous carrier may increase crystallinity of carbon and form a stable graphite layer through a heat treatment process. In this regard, the heat treatment process may be performed at a temperature of about 1500° C. to about 3000° C. in an inert gas atmosphere.

The heat treatment process may be performed according to different heat treatment temperatures, for example, in multiple stages. When the heat treatment process is performed in multiple stages, a carbon having high crystallinity may be obtained.

When the heat treatment is performed at a temperature of 1500° C. or greater, but less than 2000° C., the heat treatment of the carbonaceous carrier may be performed according to four stages as described below:

Stage 1: adjust temperature to about 900° C. to about 1100° C. at a heating rate of about 3°C./min to about 7° C./min;

Stage 2: maintain at a temperature of about 900° C. to about 1100° C. for 5 minutes to about 30 minutes;

Stage 3: adjust temperature from about 900° C. to about 1000° C. to about 1400° C. to about 2000° C. at a heating rate of about 2° C./min to about 5° C./min; and

Stage 4: maintain at a temperature of about 1400° C. to about 2000° C. for 10 minutes to about 60 minutes.

When the heat treatment is performed at a temperature of about 2000° C. to about 3000° C., the heat treatment of the carbonaceous carrier may be performed according to six stages as described below:

Stage 1: adjust temperature to about 900° C. to about 1100° C. at a heating rate of about 3° C./min to about 7° C./min;

Stage 2: maintain at a temperature of about 900° C. to about 1100° C. for 5 minutes to about 30 minutes;

Stage 3: adjust temperature from about 900° C. to about 1100° C. to about 1800° C. to about 2000° C. at a heating rate of about 2° C./min to about 5° C./min;

Stage 4: maintain at a temperature of about 1800° C. to about 2000° C. for about 10 minutes to about 30 minutes;

Stage 5: adjust temperature to about 2000° C. to about 3000° C. at a heating rate of about 1° C./min to about 3° C./min; and

Stage 6: maintain at a temperature of about 2000° C. to about 3000° C. for 10 minutes to about 60 minutes.

As described above, the carbonaceous carrier may be thermal treated at different stages and passed through a stabilization-carbonization-graphitization-high crystallization process to obtain a carbon carrier having a stable and highly crystalline structure.

When a carbonaceous carrier, including the highly crystalline carbon obtained through the heat treatment process is used, a π-π interaction between one or more phenyl rings of a C₆-C₃₀ polycyclic aromatic hydrocarbon compound having an amino group at an end thereof and carbon of a water repellent carbonaceous carrier increases hydrophilicity of the carbonaceous carrier, and the non-shared electron pair of the nitrogen of an amino group of the C₆-C₃₀ polycyclic aromatic hydrocarbon compound having an amino group at an end thereof also increases hydrophilicity of the carbonaceous carrier, such that loading the catalyst with metal such as platinum may be improved.

The instant carbonaceous carrier has a ratio of the maximum peak intensity of a D band at about 1340 cm⁻¹ to about 1360 cm⁻¹ to a maximum peak intensity of a G band at about 1575 cm⁻¹ to about 1600 cm⁻¹ (I_{D}/I_{G}), in the spectra obtained by Raman spectrometry using a laser having a wavelength of about 514.5 nm, of the carbonaceous carrier may be about 0.1 to about 1.5, for example, about 0.3 to about 1.0. Depending on the heat treatment process, a carbonaceous carrier having a specific surface area of about 50 m²/g to about 800 m²/g, and an electrode catalyst having improved durability may be manufactured by preventing carbon corrosion.

For the process of manufacturing a catalyst by loading a metal catalyst in the carbonaceous carrier, any method that is generally used in the art may be used.

The electrode catalyst may be applied to a fuel cell for a mobile and a family use, such as a fuel cell used for notebook computers, portable devices, vehicles, and buses.

For example, when an electrode catalyst layer is formed by using the instant electrode catalyst, a polymer electrolyte membrane fuel cell (PEMFC), a phosphoric acid fuel cell (PAFC), or a direct methanol fuel cell (DMFC) may be manufactured utilizing the electrode catalyst layer.

According to another embodiment of the present disclosure, provided is an electrode for a fuel cell including the electrode catalyst.

Hereinafter, a fuel cell including the electrode catalyst will be described in greater detail.

A fuel cell includes a cathode, an anode, and an electrolyte membrane disposed between the cathode and the anode, wherein at least one of the cathode and the anode includes the electrode catalyst.

For example, the cathode includes the electrode catalyst according to an embodiment.

The activity of the electrode catalyst is maintained in the fuel cell while using the fuel cell even during long periods of driving or when driving under high temperature conditions, by using the instant catalyst carrier or the catalyst.

The fuel cell may, for example, be a PEMFC or a DMFC cell.

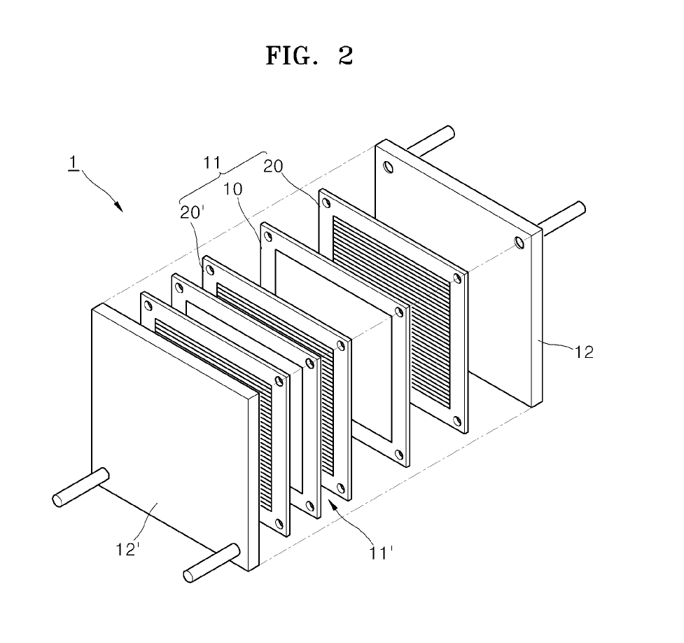

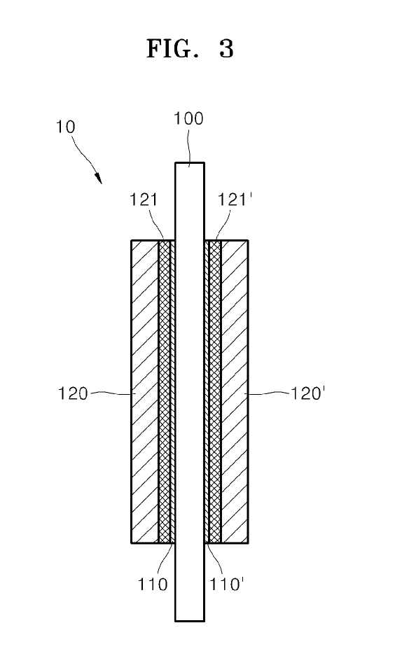

FIG. 2 is an exploded perspective view showing an embodiment of a fuel cell and FIG. 3 is a schematic view of a cross-section of a membrane electrode assembly (MEA) in a fuel cell of FIG. 2.

A fuel cell 1 shown in FIG. 2 schematically includes two unit cells 11 and 11′ disposed between a pair of holders 12 and 12′. The unit cells 11 and 11′ include a membrane-electrode assembly (MEA) 10 and bipolar plates 20 and 20′, each of which is disposed on each side of the MEA 10 in a width direction. The bipolar plates 120 and 120′ are formed of a metal having conductivity, carbon, or the like, and each of the bipolar plates 20 and 20′ binds to the MEA 10 to function as a current collector while supplying oxygen and fuel to a catalyst layer of the MEA 10.

Meanwhile, the fuel cell 100 shown in FIG. 2 has two unit cells 11 and 11′; however, the number of the unit cells is not limited to two and may be increased to dozens or a few hundred depending on the properties required by the fuel cell.

The MEA 10, as shown in FIG. 3, may include an electrolyte membrane 100 and catalyst layers 110 and 110′ may be disposed on each side of the electrolyte membrane 100 in a width direction, and the MEA 10 may include, the catalyst layers 110 and 110′ including an electrode catalyst according to an embodiment of the present disclosure, first gas diffusion layers 121 and 121′, which are respectively disposed on the catalyst layers 110 and 110′, and second gas diffusion layers 120 and 120′, which are respectively disposed on the first gas diffusion layers 121 and 121′.

The catalyst layers 110 and 110′ function as a fuel electrode and an oxygen electrode, and each of the catalyst layers 110 and 110′ include a catalyst and a binder and may further include a material that may increase the electrochemical surface area of the catalyst. The catalyst layer includes an electrode catalyst according to an embodiment of the present disclosure.

The first gas diffusion layers 121 and 121′ and the second gas diffusion layers 220 and 220′ may each be formed of a carbon sheet, a carbon paper, or the like, and diffuse oxygen and fuel supplied through the bipolar plates 120 and 120′ to the entire surface of the catalyst layers 110 and 110′.

The fuel cell 100 including the MEA 10 operates at a temperature of about 100° C. to about 300° C. Fuel such as hydrogen is supplied to one of two catalyst layers through a bipolar plate 12, 12′, and an oxidizing agent such as oxygen is supplied to the other catalyst layer through another bipolar plate 12, 12′. Also, with regard to one catalyst layer, hydrogen ions (H⁺) are generated due to the oxidation of hydrogen, and the hydrogen ions (H⁺) are conducted through the electrolyte membrane to reach the other catalyst layer. With regard to the other catalyst layer, the hydrogen ions (H⁺) and oxygen electrochemically react together to generate water (H₂O) as well as electrical energy. Also, hydrogen supplied as a fuel may be hydrogen generated through reformation of hydrocarbon or alcohol, and oxygen supplied as the oxidizing agent may be supplied as included in the air atmosphere.

Hereinafter, embodiments of the present disclosure will be described in detail, but the embodiments are not limited thereto.

### EXAMPLE 1

### Manufacturing an Electrode Catalyst and an Electrode

Ketjen black (product name: ECP, manufactured by: Mistubishi Chemical, Tokyo, Japan) was heat treated in an inert gas atmosphere according to the stages described below.

Stage 1: adjust temperature to 1000° C. at a heating rate of 5.4° C./min;

Stage 2: maintain at a temperature of 1000° C. for 10 minutes;

Stage 3: adjust temperature to 1900° C. at a heating rate of 3° C./min;

Stage 4: maintain at a temperature of 1900° C. for 5 minutes;

Stage 5: adjust temperature to 2250° C. at a heating rate of 1.7° C./min; and

Stage 6: maintain at a temperature of 2250° C. for 60 minutes.

2.0 g of heat-treated Ketjen black according to the stages described above was dispersed in 250 ml of deionized water/ethanol (95/5, v/v) to prepare a dispersion. 0.2 g of a compound represented by Formula 1 that was added to the dispersion and mixture was then stirred for 6 hours. This procedure yielded an amount of the compound represented by Formula 1 was about 10 parts by weight based on 100 parts by weight of Ketjen black.

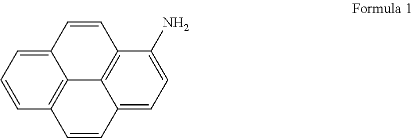 [SMILES: Nc1ccc2ccc3cccc4ccc1c2c34]

Thereafter, the resulting product was vacuum filtered, washed sequentially with distilled water, methanol, and acetone, and then vacuum dried for 24 hours to prepare a carbonaceous carrier.

0.03 g of Pt-loaded catalyst (amount of Pt: 44.8 wt %), 500 ml of Nafion (Dupont, Wilmington, Del.) solution (a solution prepared by diluting a mixture solution of 5 wt % of Nafion, 45 wt % of 1-propanol, and 50 wt % of 3-propanol by 10 times with distilled water) at a concentration of 0.5 wt %, and 4500 ml of isopropyl alcohol were mixed to prepare a catalyst composition. The mixture was sonicated for 20 minutes and then subjected to a conventional stifling process for 1 minute.

6 ul of the catalyst composition was spread on a glassy carbon electrode support having a diameter of 0.5 cm and then dried at room temperature for 5 minutes to prepare a dried product. Thereafter, 7 ul of Nafion solution (solvent: isopropyl alcohol) at 0.05 wt % was added in a drop-wise fashion onto the dried product and then dried for 10 minutes at room temperature to prepare an electrode. As a result, an amount of the loaded catalyst was present in 85 ug/cm².

### EXAMPLE 2

### Preparing an Electrode Catalyst and an Electrode

An electrode catalyst and an electrode were prepared in the same manner as in Example 1, except that the amount of the compound represented by Formula 1 was changed to 0.4 g. This procedure yielded an amount of the compound represented by Formula 1 was about 20 parts by weight based on 100 parts by weight of Ketjen black.

### EXAMPLE 3

### Preparing an Electrode Catalyst and an Electrode

An electrode catalyst and an electrode were prepared in the same manner as in Example 1, except that the amount of the compound represented by Formula 1 was changed to 1.0 g. In this regard, the amount of the compound represented by Formula 1 was about 50 parts by weight based on 100 parts by weight of Ketjen black.

### COMPARATIVE EXAMPLE 1

### Preparing an Electrode Catalyst and an Electrode

The same processes as in Example 1 were performed, except that a product obtained from heat-treating Ketjen black (ECP 300J, manufactured by: Mistubishi Chemical) at a temperature of 2250° C. for 1 hour was used as a carbonaceous carrier.

### COMPARATIVE EXAMPLE 2

### Preparing an Electrode Catalyst

The same processes as in Example 1 were performed, except that a compound represented by Formula 2 was used instead of the compound represented by Formula 1.

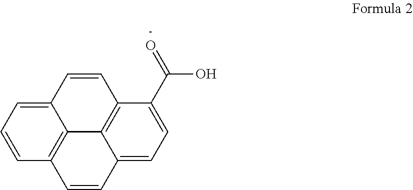 [SMILES: O=C(O)c1ccc2ccc3cccc4ccc1c2c34]

### EVALUATION EXAMPLE 1

### Transmission Electron Microscope (TEM) Analysis

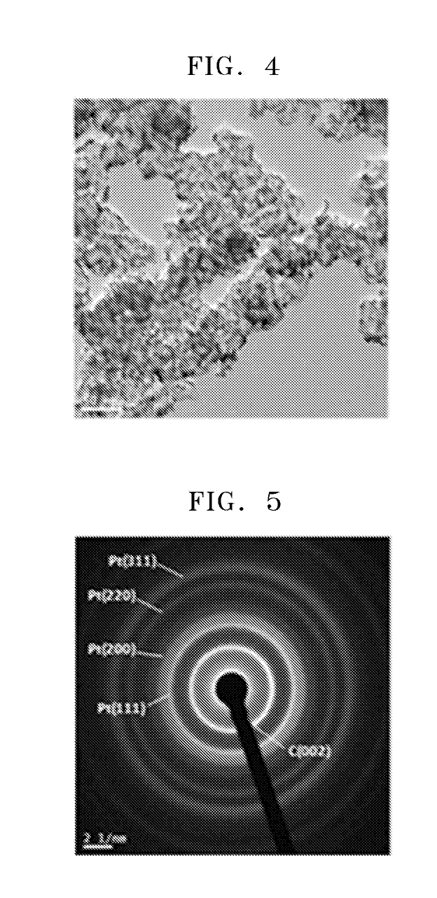

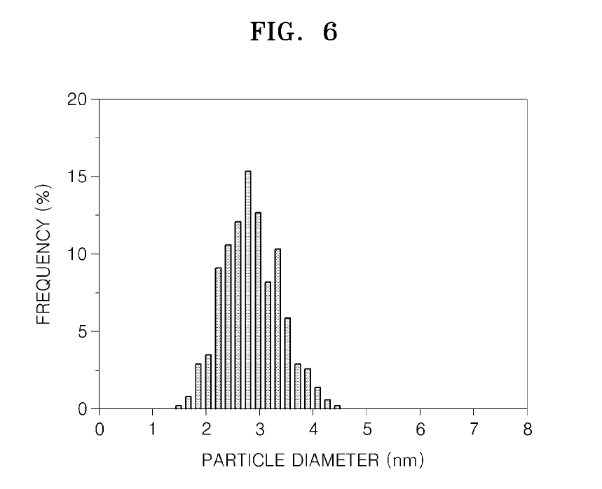

The electrode catalyst prepared according to Example 1 was analyzed through high-resolution transmission electron microscopy (HRTEM/SAED)/selected area electron diffraction (SAED) and the results obtained therefrom are shown in FIGS. 4 to 6.

FIGS. 4 to 6, show the electrode catalyst prepared in Example 1 has Pt thoroughly dispersed on a carbon carrier. Also, a series of concentric rings corresponding to a C(002) surface of crystalline carbon and Pt(111), Pt(200), Pt(220), and Pt(311) surfaces of an fcc crystal lattice of Pt were observed through SAED.

### EVALUATION EXAMPLE 2

### X-ray Diffraction (XRD) Analysis

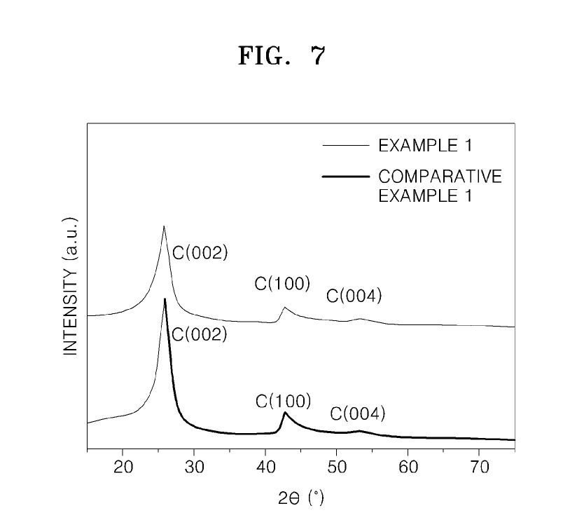

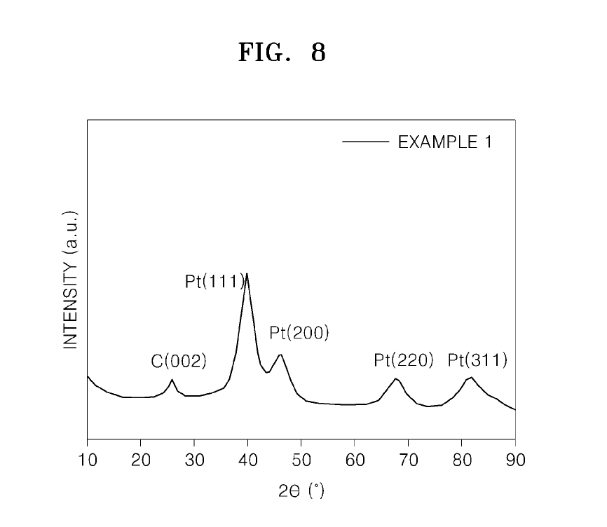

X-ray diffraction (XRD) analysis (MP-XRD, Xpert PRO, Philips/Power 3 Kw) was performed with respect to the electrode catalysts manufactured in Example 1 and Comparative Example 1 and the results obtained therefrom are shown in FIGS. 7 and 8, and Table 1.

In Table 1 below, L_{C} represents a crystalline domain size and d₍₀₀₂₎ represents interplanar spacing.

TABLE 1

| | L_{C} (Å) | d₍₀₀₂₎ (Å) |
|---|---|---|
| Comparative Example 1 | 34.1 | 3.449 |
| Example 1 | 33.9 | 3.451 |

It may be concluded from Table 1 and FIGS. 7 and 8 that the carbonaceous electrode catalyst prepared in Example 1 has Pt particles having a face-centered cubic lattice (fcc) thoroughly dispersed on a high crystalline carbon carrier.

### EVALUATION EXAMPLE 3

### Raman Spectrum Analysis

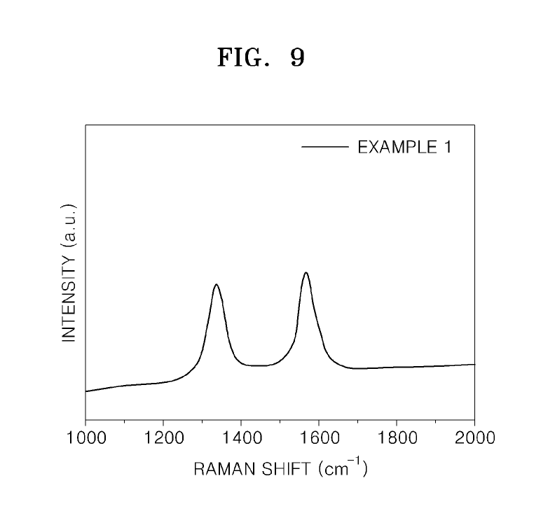

With respect to the carbonaceous carrier and the electrode catalyst used for manufacturing the electrode catalysts prepared in Examples 1 and 2 and Comparative Example 1, a maximum peak intensity of a G band at about 1575 cm⁻¹ to about 1600 cm⁻¹ and a maximum peak intensity of a D band at about 1340 cm⁻¹ to about 1360 cm⁻¹ were measured by Raman spectrometer (a product of JASCO Inc., Oklahoma City, Okla.) using a laser having a wavelength of 514.5 nm. The results obtained therefrom are shown in FIG. 9.

Also, a ratio of the maximum peak intensity of a D band at about 1340 cm⁻¹ to about 1360 cm⁻¹ to the maximum peak intensity of a G band at about 1575 cm ⁻¹ to about 1600 cm⁻¹ was calculated. The results obtained therefrom are shown in Table 2.

In Table 2 below, I_{G} represents the maximum peak intensity of a G band at about 1575 cm⁻¹ to about 1600 cm⁻¹ and I_{D} represents the maximum peak intensity of a D band at about 1340 cm⁻¹ to about 1360 cm⁻¹.

FWHM represents a half-width of a G band peak.

TABLE 2

| | FWHM (°) | I_{D}/I_{G} | I_{D}/I_{(D+G)} |
|---|---|---|---|
| Example 1 | 56.6 | 0.83 | 0.49 |
| Example 2 | 56.4 | 0.84 | 0.48 |
| Comparative | 55.4 | 0.81 | 0.48 |
| Example 1 | | | |

Referring to Table 2 and FIG. 9, the carbonaceous carrier and the electrode catalyst prepared in Examples 1 and 2 have similar crystallinity to the carbonaceous carrier and the electrode catalyst prepared in Comparative Example 1, and the carbonaceous carrier and the electrode catalyst prepared in Examples 1 and 2 maintain a reformed state without deterioration of the properties of the highly crystalline carbonaceous carrier.

### EVALUATION EXAMPLE 4

### Measuring Electrochemically Active Surface Area (ECSA) of an Electrode

0.03 g of the catalyst prepared according to Example 1 and Comparative Examples 1 and 2, 500 ml of a Nafion solution (a solution prepared by diluting a mixture solution of 5 wt % of Nafion, 45 wt % of 1-propanol, and 50 wt % of 3-propanol by 10 times with distilled water) at a concentration of 0.5 wt %, and 4500 ml of isopropyl alcohol were mixed to prepare a catalyst composition. The mixture was sonicated for 20 minutes and a conventional stifling process for 1 minute.

6 ul of the catalyst composition was spread on a glassy carbon electrode support having a diameter of 0.5 cm and then dried at room temperature for 5 minutes to prepare a dried product. Thereafter, 7 ul of Nafion solution (solvent: isopropyl alcohol) at 0.05 wt % was added to the dried product and then dried for 10 minutes at room temperature to prepare an electrode. In this regard, an amount of the loaded catalyst was about 85 ug/cm².

The electrode catalyst prepared according to the processes described above was subjected to an accelerated life testing. The accelerated life testing was performed by repeating 1000 cycles of cyclic voltammetry (CV) using the electrode prepared above, Ag/AgCl as a standard electrode, at a temperature of 25° C., in 0.1M HClO₄ aqueous solution, and a voltage between about 0.6 V to about 1.4 V based on a standard hydrogen potential.

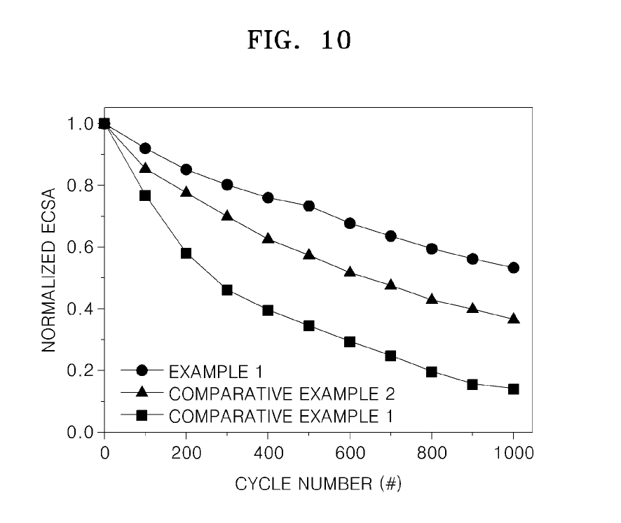

As described above, the accelerated life testing was performed for every 100 cycles at a scan rate of 20 mV/sec. Formula 1 below was used to calculate a ratio of reduction of an electrochemical surface area and then normalized. The results obtained therefrom are shown in FIG. 10.

Ratio of reduction of an electrochemical surface area=calculated surface area/initial surface area Equation 1

Referring to FIG. 10, it may be concluded that the electrode catalyst for a fuel cell prepared in Example 1 showed a smaller loss of ECSA than the electrode catalysts for a fuel cell prepared in Comparative Examples 1 and 2. Thus, it may be concluded that the extent of deterioration of the electrode catalyst for a fuel cell prepared in Example 1 is smaller than the extent of deterioration of the electrode catalysts for a fuel cell prepared in Comparative Examples 1 and 2.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. An electrode catalyst for a fuel cell comprising:
a carbonaceous carrier and a catalyst metal supported in the carbonaceous carrier,
wherein the carbonaceous carrier is non-covalently bonded to a C₆-C₃₀ polycyclic aromatic hydrocarbon compound having an amino group at an end thereof, on the surface of the carbonaceous carrier.

2. The electrode catalyst for a fuel cell of claim 1, wherein the amino group is-L-N(R₁)(R₂), and R₁ and R₂ are each independently a hydrogen, a C₁-C₁₀ alkyl group or a C₆-C₁₀ aryl group, and L simply represents a chemical bond, or a C₂-C₁₀ akylene group or a C₆-C₁₀ arylene group.

3. The electrode catalyst for a fuel cell of claim 1, wherein the C₆-C₃₀ polycyclic aromatic hydrocarbon compound having an amino group at an end thereof, is at least one selected from an naphthalene compound having an amino group at an end thereof, phenanthrene compound having an amino group at an end thereof, an pyrene compound having an amino group at an end thereof, and an anthracene compound having an amino group at an end thereof.

4. The electrode catalyst for a fuel cell of claim 1, wherein the C₆-C₃₀ polycyclic aromatic hydrocarbon compound having an amino group at an end thereof, is a compound represented by Formula 1 below; a compound represented by Formula 2 below; an anthracene compound comprising at least one amino group selected from the group consisting of —NH₂, and —(CH₂)ₙNH₂, wherein n is an integer from 1 to 10; a phenanthrene compound comprising at least one amino group selected from the group consisting of —NH₂ and —(CH₂)ₙNH₂, (wherein n is an integer from 1 to 10); a tetracene compound comprising at least one amino group selected from the group consisting of —NH₂ and —(CH₂)ₙNH₂ wherein n is an integer from 1 to 10; a pentacene compound comprising at least one amino group selected from the group consisting of —NH₂ and —(CH₂)ₙNH₂ (wherein n is an integer from 1 to 10); or a triphenylene compound comprising at least one amino group selected from the group consisting of —NH₂ and —(CH₂)ₙNH₂wherein n is an integer from 1 to 10: 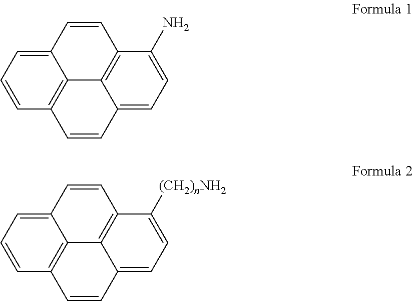
in Formula 2, n is an integer from 1 to 10.

5. The electrode catalyst for a fuel cell of claim 1, wherein an amount of the C₆-C₃₀ polycyclic aromatic hydrocarbon compound having an amino group at an end thereof, is about 0.1 parts by weight to about 50 parts by weight based on 100 parts by weight of the carbonaceous carrier.

6. The electrode catalyst for a fuel cell of claim 1, wherein the carbonaceous carrier is carbon black, heat-treated carbon black, heat-treated acetylene black, activated carbon, graphite, highly pure graphite, carbon nanofibers, carbon fibers, carbon nanotubes, carbon nanowires, carbon nanocages, carbon nanohorns, carbon aerogel, carbon nanorings, mesoporous carbon, ordered mesoporous carbon, graphene, or a combination thereof.

7. The electrode catalyst for a fuel cell of claim 1, wherein an amount of the carbonaceous carrier that is non-covalently bonded to the C₆-C₃₀ polycyclic aromatic hydrocarbon compound having an amino group at an end thereof on the surface of the carbonaceous carrier is about 20 parts by weight to about 80 parts by weight based on 100 parts by weight of the total weight of the electrode catalyst.

8. The electrode catalyst for a fuel cell of claim 1, wherein a ratio of the maximum peak intensity of a D band at about 1340 cm⁻¹ to about 1360 cm⁻¹ to a maximum peak intensity of a G band at about 1575 cm⁻¹ to about 1600 cm⁻¹, which is obtained by Raman spectrometry using a laser having a wavelength of 514.5 nm, is about 0.1 to about 1.5.

9. The electrode catalyst for a fuel cell of claim 1, wherein in the XRD spectrum of the carbonaceous carrier, a peak with respect to a (002) surface is observed at a Bragg 2θ angle of 26.4±0.1°, and a half-width of the peak with respect to the (002) surface is about 0.2° to about 0.7°.

10. The electrode catalyst for a fuel cell of claim 1, wherein the metal catalyst is at least one selected from the group consisting of platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), strontium (Sn), titanium (Ti), chromium (Cr), and a combination thereof.

11. An electrode for a fuel cell comprising the electrode catalyst of claim 1.

12. The electrode of claim 11, comprising an electrode catalyst wherein the amino group is -L-N(R₁)(R₂), and R₁ and R₂ are each independently a hydrogen, a C₁-C₁₀ alkyl group or a C₆-C₁₀ aryl group, and L simply represents a chemical bond, or a C₂-C₁₀ akylene group or a C₆-C₁₀ arylene group.

13. The electrode of claim 11, comprising an electrode catalyst wherein the amino C₆-C₃₀ polycyclic aromatic hydrocarbon compound is at least one selected from an amino naphthalene compound, an phenanthrene compound, an amino pyrene compound, and an amino anthracene compound.

14. The electrode of claim 11, comprising an electrode catalyst wherein the amino C₆-C₃₀ polycyclic aromatic hydrocarbon compound is a compound represented by Formula 1 below; a compound represented by Formula 2 below; an anthracene compound comprising at least one amino group selected from the grouping consisting of —NH₂, and —(CH₂)ₙNH₂, wherein n is an integer from 1 to 10; a phenanthrene compound comprising at least one amino group selected from the group consisting of —NH₂ and —(CH₂)ₙNH₂ (wherein n is an integer from 1 to 10); a tetracene compound comprising at least one amino group selected from the group consisting of —NH₂ and —(CH₂)ₙNH₂ wherein n is an integer from 1 to 10; a pentacene compound comprising at least one amino group selected from the group consisting of —NH₂ and —(CH₂)ₙNH₂ (wherein n is an integer from 1 to 10); or a triphenylene compound comprising at least one amino group selected from the group consisting of —NH₂ and —(CH₂)ₙNH₂ wherein n is an integer from 1 to 10: 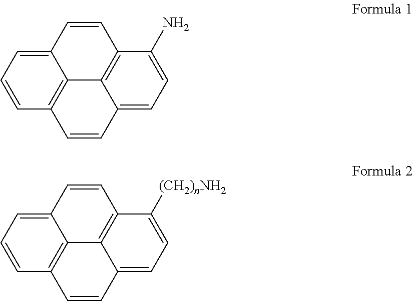
in Formula 2, n is an integer from 1 to 10.

15. The electrode of claim 11, comprising an electrode catalyst wherein an amount of the amino C₆-C₃₀ polycyclic aromatic hydrocarbon compound is about 0.1 parts by weight to about 50 parts by weight based on 100 parts by weight of the carbonaceous carrier.

16. The electrode of claim 11, comprising an electrode catalyst wherein the carbonaceous carrier is carbon black, heat-treated carbon black, heat-treated acetylene black, activated carbon, graphite, highly pure graphite, carbon nanofibers, carbon fibers, carbon nanotubes, carbon nanowires, carbon nanocages, carbon nanohorns, carbon aerogel, carbon nanorings, mesoporous carbon, ordered mesoporous carbon, graphene, or a combination thereof, and an amount of the carbonaceous carrier that is non-covalently bonded to the C₆-C₃₀ polycyclic aromatic hydrocarbon compound having an amino group at the end thereof on the surface of the carbonaceous carrier is about 20 parts by weight to about 80 parts by weight based on 100 parts by weight of the total weight of the electrode catalyst.

17. The electrode of claim 11, comprising an electrode catalyst wherein a ratio of the maximum peak intensity of a D band at about 1340 cm⁻¹ to about 1360 cm⁻¹ to a maximum peak intensity of a G band at about 1575 cm⁻¹ to about 1600 cm⁻¹, which is obtained by Raman spectrometry using a laser having a wavelength of 514.5 nm, is about 0.1 to about 1.5.

18. The electrode of claim 11, comprising an electrode catalyst wherein in the XRD spectrum of the carbonaceous carrier, a peak with respect to a (002) surface is observed at a Bragg 2θ angle of 26.4±0.1°, and a half-width of the peak with respect to the (002) surface is about 0.2° to about 0.7°.

19. The electrode for a fuel cell of claim 1, wherein the electrode is a cathode.

20. A fuel cell comprising:
a cathode,
an anode that is disposed opposite to the cathode, and
an electrolyte membrane disposed between the cathode and the anode, wherein at least one of the cathode and the anode comprises the electrode catalyst of claim 1.
